(19) United States
(12) Patent Application Publication
(10) Pub. No.: US 2025/0140134 A1
(43) Pub. Date: May 1, 2025

(54) BADGE

(71) Applicant: "Les Graveurs" Münz- und Medaillengestaltung und Gravuren GmbH, Heimsheim (DE)

(72) Inventor: Tobias Dalacker, Niefern-Öschelbronn (DE)

(73) Assignee: "Les Graveurs" Münz- und Medaillengestaltung und Gravuren GmbH, Heimsheim (DE)

(21) Appl. No.: 18/932,019

(22) Filed: Oct. 30, 2024

(30) Foreign Application Priority Data
Oct. 31, 2023 (DE) 102023130144.6

(51) Int. Cl. G09F 3/16

(52) U.S. Cl. CPC G09F 3/16

(57) ABSTRACT

A badge for attaching a label to a flat object has a label carrier and a mounting element as well as a connecting arrangement arranged between the label carrier and the mounting element, which has at least one spacer and a label carrier-side connector and a mounting element-side counter connector connectable thereto for fixing the mounting element spaced apart from the label carrier while forming a receiving area for a part of the flat object. The label carrier and the mounting element are connected to one another via an edge section and are held pivotably spaced apart from one another.

The invention relates to a badge for attaching a label to a flat and flexible object, such as a mat, a carpet, or a seat cover in particular, for example for use in a motor vehicle, according to the preamble of claim 1. For this purpose, the badge has a label carrier, which is in particular plate-shaped, and a mounting element, which is also in particular plate-shaped. In addition, the badge has a connectable connecting arrangement between the label carrier and the mounting element, which comprises at least one spacer and label carrier-side connecting means and mounting element-side connecting counter-means, which are used for spaced-apart fixing of the mounting element to the label carrier while forming a receiving area for a part of the flat object.

A device for arranging an emblem on a piece of furniture is known from DE102019104972B3. This has a carrier plate which is connected to an emblem, also in the form of a plate, by means of an adhesive connector. The carrier plate can also be connected to a counterpart by means of a connecting element in such a way that the piece of furniture in question is clamped between the support plate and the counterpart. The connecting element is formed, for example, by a pin, threaded bolt, and/or dome.

The disadvantage of the known badge device is that it causes relatively high production costs and a high assembly effort due to the number of individual parts required.

The object of the invention is to avoid the above-mentioned disadvantages in a generic badge and to reduce the production costs as well as the assembly effort.

This object is achieved by a badge having the features of claim 1. The label carrier and the mounting element are connected to one another via an edge section and are held pivotably at a distance from one another. This allows the label carrier to be handled together with the mounting element as a single component. Both elements are held together captively even during assembly and are connected to one another by the edge section at a predetermined distance, which reduces the assembly effort. In addition, the label carrier, the mounting element, and the edge section connecting them can be produced as a contiguous component, by which production costs can also be reduced.

In a particularly preferred embodiment, the label carrier, the mounting element, and the edge section are adjustable between a starting position in which all three parts are arranged in a plate-like manner in one plane and an assembly position in which the label carrier and the mounting element are arranged parallel and spaced apart from one another. Due to the common plate-shaped arrangement in the starting position, the three parts of the badge are producible particularly easily in one piece. In addition, the badge can be mounted particularly easily on a flat object due to the possibility of aligning the label carrier parallel to the mounting element at a predetermined distance.

Advantageously, the edge section is connected to the label carrier via a first film hinge and to the mounting element via a second film hinge, wherein both film hinges extend parallel to one another. In this way, the connecting areas together with the label carrier, the edge section, and the mounting element are producible easily as a single piece. In addition, the film hinges ensure that the label carrier is pivotable stably and precisely relative to the mounting element.

In this case, it is advantageous if the label carrier, the mounting element, and the edge section are formed in one piece by a one-piece carrier plate, which is produced from plastic, for example. This makes it possible to produce the badge particularly cost-effectively.

It is particularly advantageous if the connecting arrangement is also formed in a single piece with the carrier plate in order to be able to produce and assemble the entire badge together with the required fastening means as a single, contiguous component. In this way, the assembly effort in particular can be minimized.

In a particularly advantageous embodiment, the carrier plate and the connecting arrangement are formed by a molded part which, in the starting position, at least substantially defines a single demolding direction. This makes it possible to produce the badge particularly cost-effectively using a mold-casting process, particularly from a plastic.

Preferably, the at least one spacer protrudes from an inner side of the label carrier and has at a free end the label carrier-side connecting means, which are connectable to the mounting element-side connecting counter means. This makes it possible, with the alignment of the label carrier parallel to the mounting element, to simultaneously establish the connection between the two parts via the at least one spacer by connecting the connecting means to the connecting counter means.

It is advantageous if the label carrier-side connecting means are formed by locking means which can be locked with the mounting element-side connecting counter means designed as locking counter means. This enables a particularly simple connection between the connecting means and the connecting counter means.

Alternatively or additionally, the label carrier-side connecting means are formed by at least one clamping element which can be clamped on the at least one spacer. In this way, the connecting means can also be connected to spacers which have a smooth surface and are therefore easier to produced, for example, in particular in a mold casting method having only one demolding direction.

In a preferred embodiment, the label carrier-side connecting means are embedded in an inner surface of the carrier plate in such a way that an outer surface facing away from it is closed. The closed outer surface can provide the badge with a higher visual value when fixed.

Advantageously, the connecting arrangement also has at least two spacers, via which the connection between the label carrier and the mounting element can be established. This ensures that the badge is stably fixed on the object to be marked. In addition, better stiffening is producible between the label carrier and the mounting element in this way.

Preferably, the label carrier also has a milled label, which ensures a permanent and stable labeling of the object in question with almost constant quality over the lifetime of the label. As an alternative to a label embedded in the label carrier, a raised label or a combination of both can also be formed. The label can be produced in any known and suitable manner, for example, in particular by milling, punching, embossing, or deep-drawing, and/or by gluing or welding on a separate label element.

It should be noted that all features of the subject matter according to the invention described above can be exchanged or combined with one another, provided that an exchange or a combination thereof is not ruled out for technical reasons.

An exemplary embodiment of the invention is shown in the figures. In the figures:

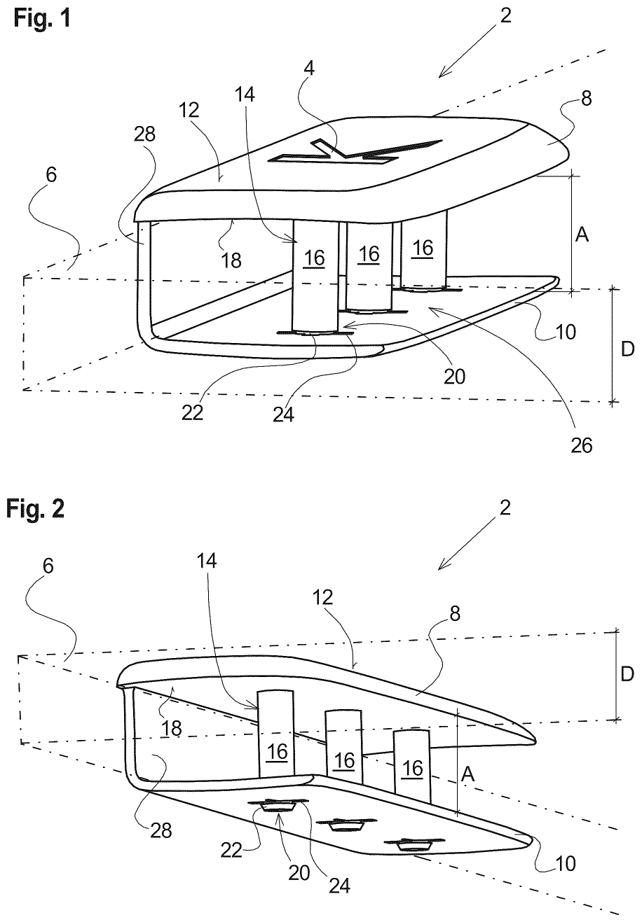

FIG. 1 shows a perspective top view of a badge according to the invention in an assembly position,

FIG. 2 shows a perspective bottom view of the badge according to FIG. 1,

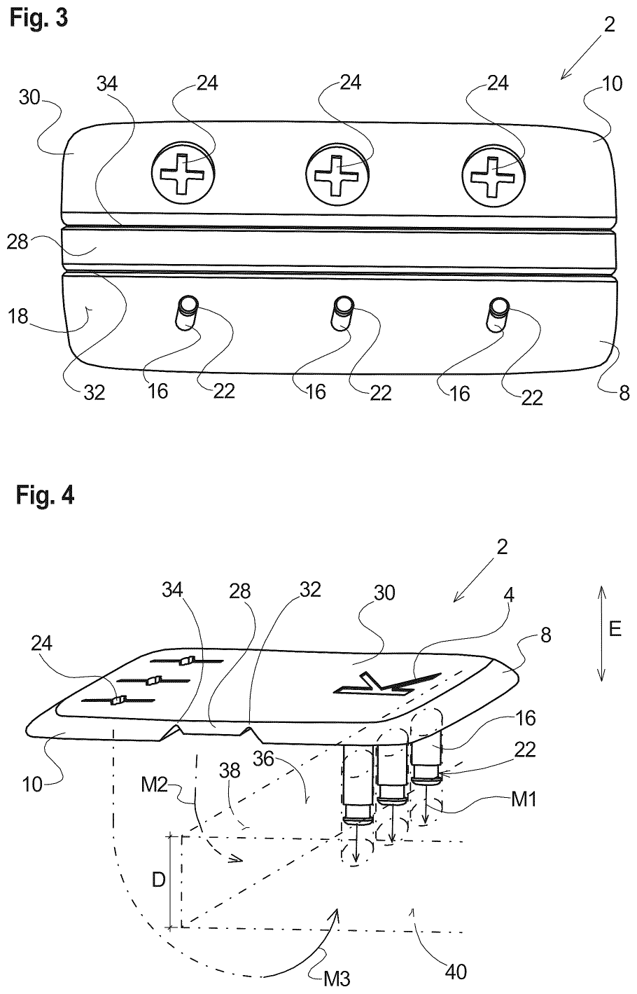

FIG. 3 shows a top view of the badge in an starting position,

FIG. 4 shows a perspective view of the badge according to FIG. 3 at the beginning of an assembly process, and

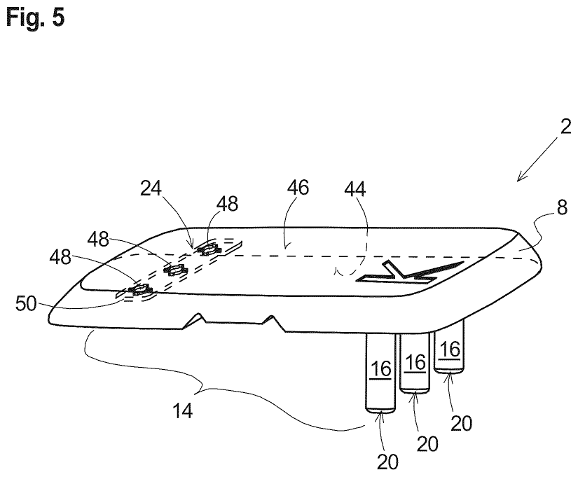

FIG. 5 shows a perspective view of the badge according to FIG. 4 with an alternative embodiment of a connecting arrangement.

FIGS. 1 and 2 show a badge 2 for attaching a label 4 to a flat object 6. The flat object 6 is produced in particular from a flexible material, such as a textile material or an elastomer or rubber material. The flat object 6 forms, for example, a mat, a carpet, a cover, or another interior furnishing object, for example, in particular in the interior of a motor vehicle.

In order to reproduce and attach the label 4 to the flat object 6, the badge 2 has a plate-shaped label carrier 8 and a mounting element 10 which is also plate-shaped. The label carrier 8 is produced, for example, from a plastic or from a metal, wherein the label 4 is attached to an outer side 12 of the label carrier 8, preferably in the form of a milling. Alternatively, the label K can also be produced on the label carrier 8 by any other known and suitable manner, such as by punching or embossing, deep drawing, and/or by gluing or welding on an additional label element.

Between the label carrier 8 and the mounting element 10, the badge 2 has a connecting arrangement 14, which is in particular connectible permanently. This comprises at least one spacer 16 which protrudes from an inner side 18 of the label carrier 8 facing away from the outer side 12 and which forms label carrier-side connecting means 22 at a free end 20. Preferably, at least two spacers are provided, each of which has connecting means 22 on the label carrier side. These are connected to mounting element-side connection counter means 24, which are formed on the mounting element 10.

FIGS. 1 and 2 show the connecting means 22 and the connecting counter means 24 in a connected state, due to which the badge 2 assumes a assembly position. In this assembly position, the plate-shaped label carrier 8 and the likewise plate-shaped mounting element 10 are arranged substantially parallel to one another. The badge 2 encloses a receiving area 26 between the label carrier 8 and the mounting element 10, in which a part of the flat object 6 can be received or clamped.

As can also be seen from FIGS. 1 and 2, the label carrier 8 and the mounting element 10 are connected via an edge section 28 which, in the assembly position, in conjunction with the at least one spacer 16 of the connecting arrangement 14, defines a predetermined distance A between the label carrier 8 and the mounting element 10 arranged parallel thereto or a width of the receiving area 26. This distance A is adapted to a material thickness D of the flat object 6 in order to preferably enable a certain clamping of the badge 2 on the object 6 in the mounted state.

FIGS. 3 and 4 show the badge 2 in an starting position in which the label carrier 8, the mounting element 10, and the edge section 28 lie in a common plane and thereby form a one-piece carrier plate 30 or a one-piece component. As can be seen, the label carrier 8 is connected to the edge section 28 via a first film hinge 32 and the mounting element 10 via a second film hinge 34.

As can also be seen from FIGS. 3 and 4, the connecting means 24 and the connecting counter means 24 are also formed in one piece with the carrier plate 30. For this purpose, the badge 2 can be produced as a whole, for example, by a single molded part, in particular made of a plastic. The label carrier-side connecting means 22 are formed, for example, by locking means, such as an undercut and thus lockable head. In order to connect the connecting means 22 with the connecting counter means 24 in the assembly position, the latter are formed, for example, by locking counter means, for example, in the form of a locking recess. As an alternative to the locking arrangement shown, the label carrier-side connecting means 22 and the mounting element-side connecting counter means 24 can also be formed by any other known and suitable connecting arrangement.

The badge 2 or the carrier plate 30 having the spacer 16 and the connecting means 24 essentially define a single demolding direction E, as shown in FIG. 4. In this case, only the undercut areas on the spacers 16 are reworked or produced by additional molding means.

To fasten the badge 2 to the flat object 6, the at least one spacer 16 is inserted on an upper side 36 along a first mounting direction M1 according to FIG. 4 through a corresponding number of fastening recesses 38 which are previously incorporated into the flat object 6. In order to enable a particularly positionally stable fastening, the badge 2 has at least two spacers 16 which interact with a corresponding number of fastening recesses 38 which are adapted in shape and size to a cross section of the spacers and, for example, have a circular or elliptical shape or are polygonal.

As soon as the label carrier 8 bears on the upper side 36 of the object 6, the edge section 28 can then be pivoted around the first film hinge 32 along a second mounting direction M2 and, for example, placed against an edge 40 of the object 6. Finally, the mounting element 10 is pivoted along a third mounting direction M3 around the second film hinge 34 and placed against an underside 42 of the flat object 6. The label carrier-side connecting means 22 now engages with the mounting element-side connecting counter means 24, by which the badge 2 is fixed on the flat object 6. The badge 2 now assumes the assembly position according to FIGS. 1 and 2, in which the label 4 is fixed to the upper side 36 of the flat object 6 and is visible.

Alternatively to the mounting element-side connecting means 24 shown in FIGS. 1 to 4, which are designed as continuous recesses or as continuous locking receptacles on the mounting element 10, these can also be only embedded in an inner surface 44 of the mounting element 10 in accordance with FIG. 5 in such a way that an outer surface 46 of the mounting element 10 facing away therefrom remains closed. For this purpose, the connecting means 24 on the mounting element side can, for example, have clamping elements 48, which are each connectible to a free end 20 of the spacers 16.

The clamping elements 48 can be formed, for example, by self-clamping clamping disks, which can be connected in a force-fitting manner to the spacers 16, even without an undercut formed thereon. The clamping elements 48 can be formed, for example, by commercially available clamping disks and can be held for fixing to the inner surface 44 of the mounting element 10, for example, on a mounting plate 50 which is, for example, glued or welded to the inner surface 44. Alternatively, the clamping element 48 can also be integrated into the mounting plate 50 to further simplify the fastening to the mounting element 10.

It should be noted that all elements and features of the various embodiments of the subject according to the invention described above can be exchanged or combined with one another, provided that an exchange or a combination thereof is not ruled out for technical reasons.

1. A badge for attaching a label to a flat object, comprising:
a label carrier;
a mounting element; and
a connecting arrangement arranged between the label carrier and the mounting element, the connecting arrangement having at least one spacer and a label carrier-side connector and a mounting element-side counter connector connectable to the label carrier-side connector for fixing the mounting element spaced apart from the label carrier while forming a receiving area for a part of the flat object,
wherein the label carrier and the mounting element are connected to one another via an edge section and are held pivotably spaced apart from one another.

2. The badge according to claim 1, wherein the label carrier, the mounting element, and the edge section are adjustable between a starting position in which all three parts of the label carrier, the mounting element, and the edge section are arranged in a plate-like manner in one plane and an assembly position in which the label carrier and the mounting element are arranged substantially parallel and spaced apart from one another.

3. The badge according to claim 2, wherein the edge section is connected to the label carrier via a first film hinge and to the mounting element via a second film hinge, and wherein both film hinges of the first film hinge and the second film hinge extend parallel to one another.

4. The badge according to claim 2, wherein the label carrier, the mounting element, and the edge section are formed in one piece by a carrier plate.

5. The badge according to claim 4, wherein the connecting arrangement is formed in one piece with the carrier plate.

6. The badge according to claim 5, wherein the carrier plate and the connecting arrangement (14) are formed by a molded part which defines a demolding direction in the starting position.

7. The badge according to claim 1, wherein the at least one spacer protrudes from an inner side of the label carrier and has at a free end the label carrier-side connector which is connectible to the mounting element-side counter connector.

8. The badge according to claim 1, wherein the label carrier-side connector is formed by a lock, which is lockable with the mounting element-side counter connector designed as a counter lock.

9. The badge according to claim 1, wherein the label carrier-side connector is formed by at least one clamp which can be clamped to the at least one spacer.

10. The badge according to claim 8, wherein the label carrier-side connector is embedded in an inner surface of the carrier plate in such a way that an outer surface facing away therefrom is closed.

11. The badge according to claim 1, wherein the connecting arrangement has at least two spacers.

12. The badge according to claim 1, wherein the label carrier has a milled label.
